(19) United States
(12) Patent Application Publication
(10) Pub. No.: US 2018/0029822 A1
(43) Pub. Date: Feb. 1, 2018

(54) Knot Untier

(71) Applicant: Anthony Deluccia, New York City, NY (US)

(72) Inventor: Anthony Deluccia, New York City, NY (US)

(21) Appl. No.: 15/219,365

(22) Filed: Jul. 26, 2016

(51) Int. Cl. B65H 47/00; B25B 27/14; A43C 7/00

(52) U.S. Cl. CPC B65H 47/00; A43C 7/005; B25B 27/14

(57) ABSTRACT

This discloses a knot untier. The knot untier consists of an arm or pawl which is inserted into the knot to be untied plus, in some embodiments, a base which resembles a credit card. The knot untier in one embodiment is thus small enough to fit in a wallet. The knot untier may also be hung on a keychain. The knot untier does not, as many existing untiers do, damage most lines.

### CROSS-REFERENCE TO RELATED APPLICATIONS

This application is a Continuation-in-Part of that application filed Feb. 6, 2015 as Ser. No. 14/615,598 which in turn is a Continuation-in-Part of that application filed Oct. 2, 2013 as Ser. No. 14/026,403. This application also claims the benefit of U.S. Provisional Application No. 61/727,994, filed Nov. 19, 2012, the entireties of all of which are incorporated herein by reference.

### FIELD OF THE INVENTION

The present invention relates generally to hand tools, and more particularly, relating to hand tools for untying knots.

### BACKGROUND OF THE INVENTION

Tying and untying knots is an everyday event for nearly' all in the US and other countries. It can be as simple an event as untying the laces on a pair of shoes, untying a string on a package, or untying a necktie. Most of these knots are easy to untie. However, there are knots that would have challenged Alexander the Great when he was faced with the mythical Gordian Knot. Few of us can use Alexander's solution of cleaving the knot with a sword. If a child has had the laces on play shoes double-knotted, mothers want to preserve the laces. To make matters worse, the child may have gotten the laces wet and tightened the knots. A wet, double-knot on a child's shoelace can be difficult to untie with existing methods. It is difficult to make a child hold still for long while the knot is being untied. This knot untier will make quick work of the job. This will avoid a need to discipline the child for fidgeting or resisting.

Anyone who fishes regularly has had to untie the snarl, knot-ball, or “bird's nest” in fishing line Which may occur, usually after a reel backlash. Speaker wires or computer wires or Christmas tree bulbs can be put in a box for storage. When the box is opened months later, it is as if the wires deliberately tied themselves together in order to make a simple job far more difficult. To use the wires again, the knots must be undone without damaging the wires.

A common solution to untying such knots, if the knots will not yield to efforts without tools, is to use a pointed implement, such as, an awl or marlinspike. A number of tools using such pointed elements have been patented. Many are so bulky they wind up in toolboxes Where they are out when a person needs them. They cannot be carried on a keychain or in a wallet or pocket.

Tools with sharp edges or sharp pointed ends have problems. In untying tight knots, the sharp pointed end is pushed between strands of the knot. The user must push upwards or somehow loosen the knot. Often, that means forcing against a strand, which forcing simply tightens the knot-ball at another point. Sometimes the sharp pointed element damages the strands. Monofilament is weakened substantially when damaged by a sharp implement. Under tension, such as, when there is a fish on the line, damaged monofilament line can break with predictable results, often loss of the fish and tackle. Thus, a proper knot untier should have no sharp points or sharp edges.

An ideal knot untier should be small enough to be easily carried in the pocket of a user's shirt or pants or in a wallet or purse or the knot untier should be capable of being carried on a key ring or key chain.

### SUMMARY OF THE INVENTION

The tool is a relatively flat, relatively rectangular plate or base. One or more arms extend from the base. The preferred embodiment has two arms extending from opposite sides of the base. As a practical matter, because the base is relatively rectangular, thus having four sides, the tool has at most four arms.

In the preferred embodiment, the arms can be constructed as a part of the base by stamping or machining. At the end of the arm distal from the base, each arm has a pointed portion which lies on or near the centerline of the arm, which centerline is parallel to the centerline of that part of the base from which the arm extends. The point has a slightly rounded tip in keeping with there being no sharp edges or sharp points on the tool.

The tool resembles a small credit card. This similarity to a credit card has the other advantage that the knot untier can be carried in a wallet, pocket, or purse the same way a credit card can. In most embodiments, there are apertures which allow the user to attach the tool to a key ring or key chain.

The knot untier in the preferred embodiment measures about 1.3 inches wide by about 2.0 inches long and about one-eighth of an inch thick. In the preferred embodiment the arms are about 1.2 inches long.

One of the advantages of the present invention over existing knot untiers is that the present invention has no moving parts. Moving parts make an invention more complicated and, thus, more costly. Moving parts can snag. They can break and make the tool unusable.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality.

In the drawings:

FIG. 1 is a perspective view of the knot untier constructed in accordance with the principles of the present invention;

FIG. 2 is a top or bottom view of the knot untier.

FIG. 3 is an end view of the knot untier, showing the end with the arms nearest.

FIG. 4 is an end view of the knot untier, showing the end furthest from the arms.

FIG. 5 is a side view of either side of the knot untier.

FIG. 6 is a top view of an alternate embodiment of the knot untier where the center portion is not open. In this view the arms are also shorter than the arms shown in FIG. 1.

### DETAILED DESCRIPTION OF THE INVENTION

As a preliminary matter,it should be noted that in this document (including the claims), directional terms, such as, “above”, “below”, “upper”, “lower”, etc., are used for convenience in referring to the accompanying drawings. Additionally, it is to be understood that the various embodiments of the invention describe herein may be utilized in various orientations, such as, inclined, inverted, horizontal, vertical, etc., without departing from the principles of the invention.

In this description, references to “one embodiment” or “an embodiment” mean that the feature being referred to is included in at least one embodiment of the invention. Moreover, separate references to “one embodiment” in this description do not necessarily refer to the same embodiment Illustrated embodiments are not mutually exclusive, unless so stated, and except as will be readily apparent to those of ordinary skill in the art. Thus, the invention may include any variety of combinations and/or integrations of the embodiments described herein.

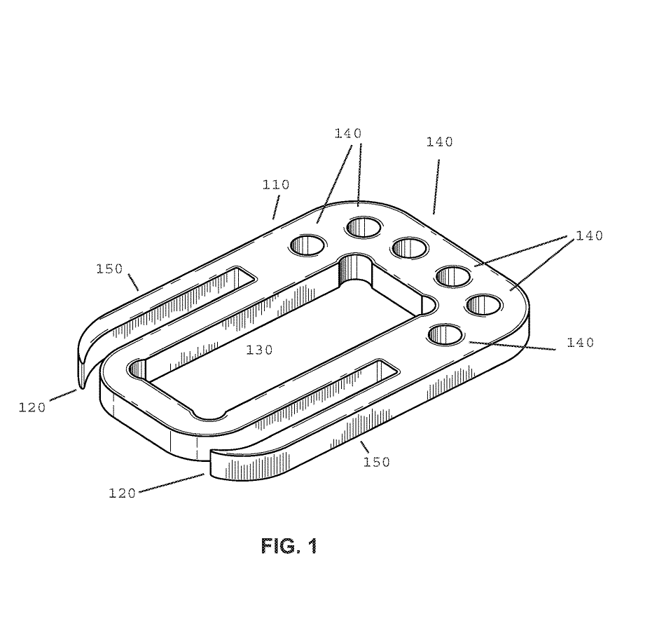

In FIG. 1, 110 is the base of the knot untier. As can be seen, in this embodiment, the knot untier is made from a single solid piece, which solid can be metal, plastic, or other similar substance. 120 is the end of the arm. The ends are pointed with a rounded tip to permit the user to insert the tip of the arm between the strands in a knot-ball without damage to the strands. In this embodiment, there are two arms, which here are the same. In other embodiments, the arms may have curves and/or points that are different from one another. In some embodiments, there may be only one arm. In some embodiments, there may be more than two arms.

130 in FIG. 1 is an open center section. When using the knot untier, an open center section allows the user to insert one or more fingers or a tool into the open section in order to get a good grip on the knot untier. The apertures 140 can serve any purpose the user wishes them to serve. If the user decides to attach the knot untier to a key chain or key ring, for example, the key chain or key ring can pass through one or more of the apertures. In this figure, there are six apertures. The number of apertures may, in alternate embodiments, vary from zero to as many as the manufacturer might wish to include.

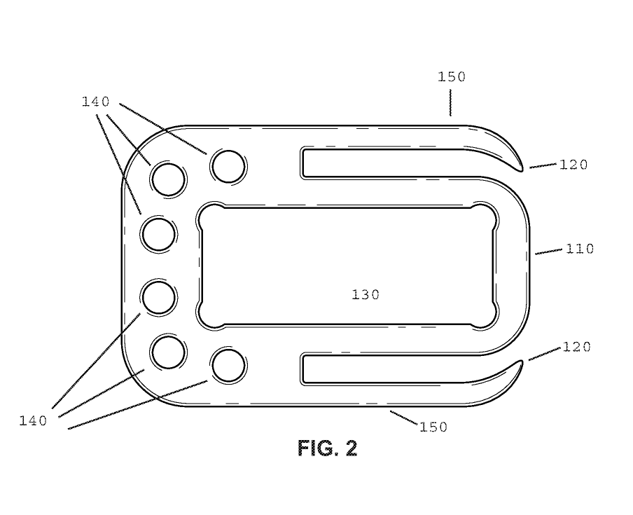

In FIG. 2, parts are the same as in FIG. 1.

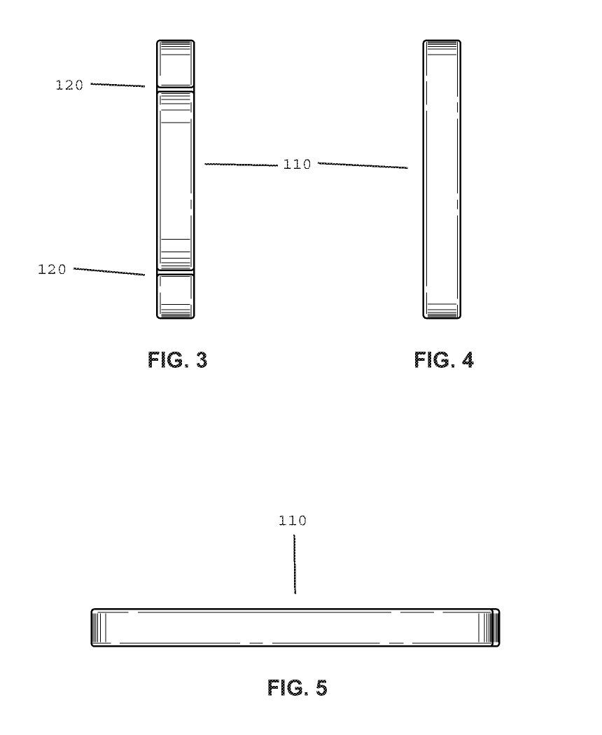

FIG. 3 shows the knot untier from the arm end.

FIG. 4 shows the knot untier from the end opposite the arm end.

FIG. 5 shows the knot untier from a side.

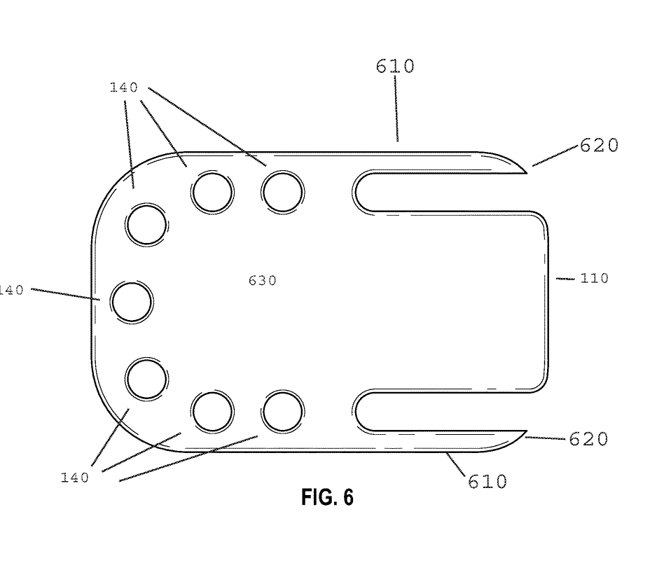

FIG. 6 shows an alternate embodiment of the knot untier. In this embodiment, there is no open center section 130. Otherwise, the knot untier is the same as in the preferred embodiment. Having no open center section makes it easier to affix names, team logos, advertizing, or other writings, which writings may be on stickers or are glued or otherwise attached to the knot untier in the area where the open center section would be on the preferred embodiment.

FIG. 6 shows another element of an alternate embodiment. The arms 610 in this embodiment are shorter than the arms shown in FIGS. 1 and 2. In this particular embodiment, the arms are only 0.75 inches long. In larger or smaller embodiments of the knot untier, the arms can be proportionately larger or smaller as the application might require. Otherwise, the arms are the same as in other embodiments disclosed herein. The benefit of the shorter arms is that they are less likely than the longer arms to bend if subjected to great tension. As a result, the knot untier with shorter arms can be made thinner or of different material than in the preferred embodiment. Longer arms are useful for penetrating larger knot balls.

The elements of the alternate embodiments disclosed above, namely, a center section that is open or not open, shorter or longer arms, large or small bases, and single or multiple arms that are the same or different from one another may be combined with one another in various combinations to form more alternate embodiments. The lengths, sizes, or tips of the arms on any base need not be identical to one another. For example, the shorter arms may be combined with an open center section on yet another embodiment of the knot untier. Thus, there exist a very large number of embodiments of the knot untier.

A number of embodiments of the present invention have been described. Nevertheless, it will be understood that various modifications may be made without departing from the spirit and scope of the invention. Accordingly, other embodiments are within the scope of the following claims.

I claim as follows:

1. A knot untier with no moving parts, no sharp points, and no sharp edges, and comprising a relatively rectangular base part and one or more arm parts extending from the base part.

2. The knot untier of claim 1 where the one or more arm parts are constructed from the same relatively flat plate of metal, plastic, or other solid material.

3. The knot untier of claim 2 with the end of said arm part distal from the base part being pointed with a rounded tip where said rounded tip is on or near the centerline of said arm part.

4. The knot untier of claim 2 where the base part contains an open center section through which a user may insert fingers or a tool in order to grip the knot untier.

5. The knot untier of claim 2 where the base part has no open center section.

6. (canceled)

7. (canceled)

8. (canceled)

9. A device for untying knots comprising a base part and one or more arm parts extending from the base part.

10. The device of claim 9 where the end part of the one or more arm parts has a slightly rounded tip such that when untying a knot said tip is inserted into the knot between the strands of the knot and is pushed into the knot to loosen the knot.
